(19) United States
(12) Patent Application Publication
(10) Pub. No.: US 2008/0294397 A1
(43) Pub. Date: Nov. 27, 2008

(54) ANALYTICAL METHOD, RECORDING MEDIUM, AND ANALYZING APPARATUS

(76) Inventor: Akira OHNISHI, Kashihara-shi (JP)

Correspondence Address: BIRCH STEWART KOLASCH & BIRCH, PO BOX 747, FALLS CHURCH, VA, 22040-0747, US

(21) Appl. No.: 12/121,449

(22) Filed: May 15, 2008

(30) Foreign Application Priority Data
May 17, 2007 (JP) P2007-132063

(51) Int. Cl. G06F 7/60

(52) U.S. Cl. 703/2

(57) ABSTRACT

An element dividing portion divides a to-be-analyzed object composed of a plurality of members into a plurality of finite elements. An analytical condition setting portion generates an analytical model of to-be-analyzed object by relating a physical property value of each member separately to individual finite elements. A stress field computing portion performs a simulation of applying a physical action to the analytical model and analyzes a resultant effect exerted on each finite element. A safety factor calculating portion makes a comparison between the effect exerted on each finite element and a reference value predetermined for each member to calculate a safety factor for each finite element. A display control portion effects control of display portion such that finite element whose safety factor is higher than a threshold value is represented transparently and the safety factor for each finite element is indicated with the analytical model.

### CROSS-REFERENCE TO RELATED APPLICATION

This application claims priority to Japanese Patent Application No. 2007-132063, which was filed on May 17, 2007, the contents of which are incorporated herein by reference in its entirety.

### BACKGROUND OF THE INVENTION

1. Field of the Invention

The present invention is concerned with an analytical method that involves a step of performing a simulation with use of an analytical model of an object to be analyzed and a step of displaying a result of analysis, a recording medium for recording a program for allowing a computer to execute the analytical method, and an analyzing apparatus.

2. Description of the Related Art

For example, in order to make an estimate of the strength of a product, a CAE (Computer Aided Engineering)—using structural analysis has heretofore been conducted. With a structural analysis, it is possible to obtain data representing physical quantity, such as a displacement, a stress, and a strain that is observed in each part of a product when a physical action is applied thereon. For example, the designer of the product performs a quality check on the product design by making a comparison between the data obtained through the structural analysis and the values of physical properties of the product and the specifications of the product. The data obtained through the structural analysis is not direct indicative of the quality of the product design. Therefore, knowledge about the physical properties and specifications of the product is required to evaluate the design.

As a conventional art, there is known an automatic design support system in which, for example, a stress that causes a product to rupture is obtained in advance by calculation and then a comparison is made between the thereby obtained stress and data obtained through a structural analysis (for example, refer to Japanese Unexamined Patent Publication JP-A 2005-115859). By employing such an automatic design support system, in spite of lack of knowledge about the physical properties and specifications of the product, it is possible to make evaluations of the design, thus offering convenience to users.

However, the automatic design support system of the conventional art is intended for the evaluation of an object to be analyzed that is composed of a single or a plurality of constituent components of a uniform material. That is, the automatic design support system is incapable of making evaluations of an object to be analyzed that is composed of a plurality of different materials.

### SUMMARY OF THE INVENTION

Accordingly, an object of the invention is to provide an analytical method that allows an easy evaluation of an object to be analyzed that is composed of a plurality of members, a recording medium on which a program is recorded for allowing a computer to execute the analytical method, and an analyzing apparatus.

The invention provides an analytical method comprising:

a dividing step of dividing a to-be-analyzed object composed of a plurality of members into a plurality of regions;

a model generation step of generating an analytical model of the to-be-analyzed object by relating a physical property value of each of the members separately to the individual regions;

an analysis step of performing a simulation of applying a physical action to the analytical model and analyzing a resultant effect exerted on each of the regions;

a safety factor calculation step of making a comparison between the effect exerted on each of the regions and a reference value which is set for each of the members in advance thereby to calculate a safety factor for each of the regions on an individual basis; and

a display step of indicating the safety factor for each of the regions along with the analytical model in a unified manner.

According to the invention, in the dividing step, a to-be-analyzed object composed of a plurality of members is divided into a plurality of regions. In the model generation step, the physical property value of each of the members is related separately to the individual regions to generate an analytical model of the to-be-analyzed object. The thereby generated analytical model represents the to-be-analyzed object composed of a plurality of members.

In the analysis step, a simulation of applying a physical action to the analytical model is performed and the resultant effect exerted on each of the regions is analyzed. In the safety factor calculation step, a comparison is made between the effect exerted on each of the regions and a reference value which is set for each of the members in advance thereby to calculate a safety factor for each of the regions on an individual basis. In the display step, the safety factor for each of the regions is indicated along with the analytical model in a unified manner. In this way, a simulation is performed with use of such an analytical model of the to-be-analyzed object composed of a plurality of members, and there is indicated the safety factor based on the result of analysis. Accordingly, by making a visual identification of this indication, it is possible to achieve the evaluation of the to-be-analyzed object composed of a plurality of members with ease without the necessity of having knowledge about the physical property value and so forth on each of the members.

Further, in the invention, it is preferable that, in the display step, each of the regions is displayed in transmissivity representation in accordance with a safety factor.

According to the invention, each of the regions is displayed in transmissivity representation in accordance with a safety factor. In the related art practice, if the region which exhibits a target safety factor for visual identification is located in the analytical model interiorly thereof, the region with a target safety factor for visual identification cannot be recognized without displaying the section of a fragmented portion of the analytical model. In light of this, according to the invention, for example, by setting the transmissivity of the region with a target safety factor for visual identification at a lower value and setting the transmissivity of the region with a safety factor other than the target safety factor for visual identification, namely a residual safety factor, at a higher value, even if the region with a target safety factor for visual identification is located in the analytical model interiorly thereof, the region can be visually identified, because it can be seen through the outer surface of the analytical model. In this way, not only the surface area of the to-be-analyzed object but also the inside area of the to-be-analyzed object can be evaluated with ease.

Further, in the invention, it is preferable that, in the display step, the transmissivity is so determined as to become increasingly higher as the safety factor is increased.

According to the invention, the transmissivity is so determined as to become increasingly higher as the safety factor is increased. That is, the region with a higher safety factor is represented transparently, on one hand, and the region with a lower safety factor is represented opaquely, on the other hand. By doing so, even in a case where the region with a high safety factor exists on the surface area of the to-be-analyzed object and the region with a low safety factor exists in the to-be-analyzed object interiorly thereof, through a visual identification of the display, it is possible to recognize the presence of the region with a low safety factor inside the to-be-analyzed object and thereby facilitate the evaluation of the to-be-analyzed object.

Further, in the invention, it is preferable that the predetermined reference value is a yield stress or yield strain.

According to the invention, the predetermined reference value is a yield stress or yield strain. That is, the safety factor is obtained by calculation on the basis of the yield stress or yield strain. With the adoption of such a reference value, there is indicated the safety factor of the to-be-analyzed object with respect to a yield point. This makes it possible to evaluate the to-be-analyzed object without the necessity of examining the yield stress or yield strain of each of the members one by one.

Further, in the invention, it is preferable that, in the analysis step, the effect is calculated in terms of tensor, in the safety factor calculation step, the effect expressed in tensor form is converted into a scalar form on the basis of the conversion equation predetermined separately for the individual members, and the effect, now expressed in scalar form after conversion, is compared with the reference value set for each of the members in advance.

According to the invention, in the analysis step, the effect is calculated in terms of tensor. In the safety factor calculation step, the effect expressed in tensor form is converted into a scalar form on the basis of the conversion equation predetermined separately for the individual members. In the safety factor calculation step, a comparison is made between the effect expressed in scalar form after conversion and the predetermined reference value. Therefore, in contrast to the case of making a comparison between the effect which still remains in tensor form and the predetermined reference value, the amount of operation can be reduced. Moreover, the conversion equation is set for each of the members on an individual basis. Accordingly, even it the to-be-analyzed object is composed of a plurality of members of different kinds, in contrast to the case of converting the effects exerted on all of the members into a scalar form with use of a single conversion equation, the evaluation of the to-be-analyzed object can be achieved with higher accuracy.

The invention provides a computer-readable recording medium on which a program is recorded for allowing a computer to execute:

a dividing step of dividing a to-be-analyzed object composed of a plurality of members into a plurality of regions;

a model generation step of generating an analytical model of the to-be-analyzed object by relating a physical property value of each of the members separately to the individual regions;

an analysis step of performing a simulation of applying a physical action to the analytical model and analyze a resultant effect exerted on each of the regions;

a safety factor calculation step of making a comparison between the effect exerted on each of the regions and a reference value which is set for each of the members in advance thereby to calculate a safety factor for each of the regions on an individual basis; and

a display step of indicating the safety factor for each of the regions along with the analytical model in a unified manner.

According to the invention, by allowing a computer to read the program, the above-stated analytical method can be executed by the computer. In this way, the safety factor for each of the regions is displayed along with the analytical model in a unified manner. Through a visual identification of this display, for the same reason as described above, it is possible for the user to achieve the evaluation of the to-be-analyzed object composed of a plurality of members with ease.

The invention provides an analyzing apparatus comprising:

a dividing portion which divides a to-be-analyzed object composed of a plurality of members into a plurality of regions;

a model generating portion which generates an analytical model of the to-be-analyzed object by relating a physical property value of each of the members separately to the individual regions;

an analyzing portion which carries out a simulation of applying a physical action to the analytical model and analyzes a resultant effect exerted on each of the regions;

a safety factor calculating portion which makes a comparison between the effect exerted on each of the regions and a reference value which is set for each of the members in advance thereby to calculate a safety factor for each of the regions on an individual basis; and

a display portion which indicates the safety factor for each of the regions along with the analytical model in a unified manner.

According to the invention, there is implemented an analyzing apparatus which is capable of executing the above-stated analytical method. In this construction, the safety factor for each of the regions is displayed along with the analytical model in a unified manner. Through a visual identification of this display, for the same reason as described above, it is possible for the user to achieve the evaluation of the to-be-analyzed object composed of a plurality of members with ease.

### BRIEF DESCRIPTION OF THE DRAWINGS

Other and further objects, features, and advantages of the invention will be more explicit from the following detailed description taken with reference to the drawings wherein:

FIG. 1 is a view schematically showing a constitution of an analyzing apparatus in accordance with one embodiment of the invention;

FIGS. 2A and 2B are perspective views showing a shape of an object to be analyzed represented by three dimensional configuration data in a visual manner;

FIG. 3 is a perspective view showing a sectional profile of a CAD model prepared by imaginarily dividing the to-be-analyzed object into a plurality of regions thereby to generate a mesh;

FIG. 4 is a view schematically showing the CAD model with a mesh generated and a fixing condition and pressure to be applied to the CAD model;

FIGS. 5A and 5B are views showing an analytical model under pressure and a maximum principal stress;

FIG. 6 is a view of a result of the structural analysis, illustrating a strength safety factor of each of finite elements indicated with the analytical model in a unified manner;

FIG. 7 is a flow chart showing procedural steps to be followed by the control section;

FIG. 8 is a perspective view showing a shape of the to-be-analyzed object represented by three dimensional configuration data in a visual manner;

FIG. 9 is a view schematically showing a CAD model and a fixing condition and pressure to be applied to the CAD model;

FIGS. 10A and 10B are views showing an analytical model under pressure and a maximum principal stress;

FIGS. 11A and 11B are views showing the analytical model under pressure and the indication of strength safety factor; and

FIGS. 12A and 12B are views of a result of structural analysis, illustrating a strength safety factor of each of the finite elements represented with the analytical model in a unified manner, with the transmissivity varying according to the strength safety factor.

### DETAILED DESCRIPTION

Now referring to the drawings, preferred embodiments of the invention are described below.

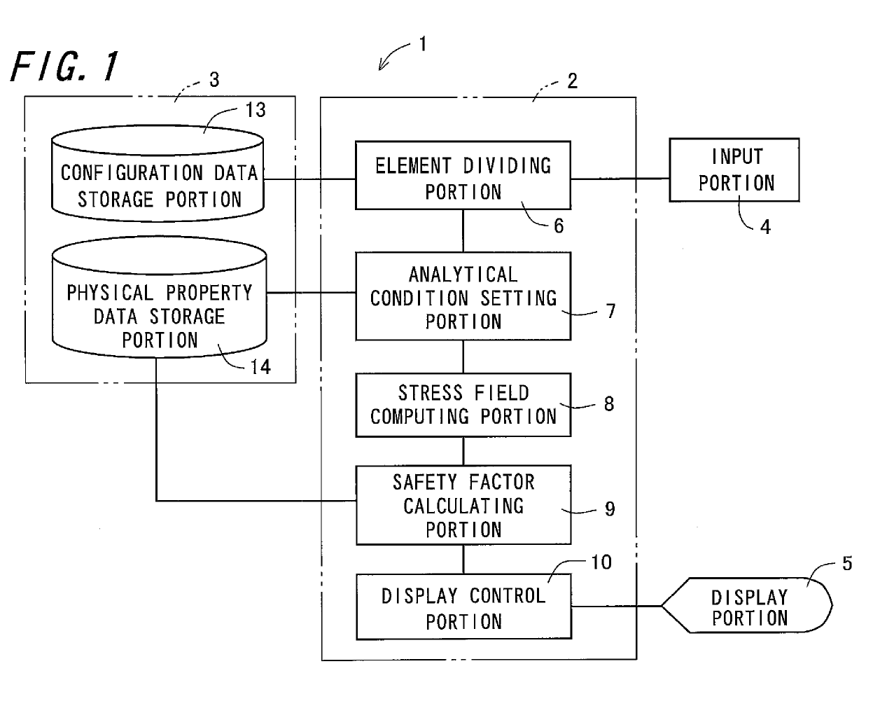

FIG. 1 is a view schematically showing a constitution of an analyzing apparatus 1 in accordance with one embodiment of the invention. The analyzing apparatus 1 is designed to perform a simulation of applying a physical action on an object to be analyzed and to display the result of analysis. In this embodiment, a structural analysis is performed in a state where, as a physical action, a pressure is applied to an object to be analyzed, and a strength safety factor is displayed by way of an analytical result.

The analyzing apparatus 1 is composed of a control section 2, a memory section 3, an input portion 4, and a display portion 5. For example, the analyzing apparatus 1 is implemented via an electronic computing machine such as a computer for use in structural analysis and a personal computer.

The control section 2 is implemented via a central processing unit (CPU for short). Through loading and execution of a control program stored in the memory section 3, the control section 2 functions as an element dividing portion 6, an analytical condition setting portion 7, a stress field computing portion 8, a safety factor calculating portion 9, and a display control portion 10. The control section 2 may be so implemented as to include a plurality of CPUs. For example, the display control portion 10 for exercising control of the display portion 5 may be implemented via a CPU specifically intended for display control. For example, the control program is recorded on a recording medium such as a flexible disk, a CD, a MO, and a DVD. Upon allowing the analyzing apparatus 1 to read the recording medium, the control program is stored in the memory section 3.

The memory section 3 is implemented via a memory device such as a ROM (Read Only Memory) and a RAM (Random Access Memory). Under the control of the control section 2, the memory section 3 provides data stored therein to the control section 2, and also stores therein data provided from the control section 2. The memory section 3 stores therein the above-stated control program, and also functions as a configuration data storage portion 13 for storing three dimensional configuration data representing the shape of an object to be analyzed and a physical property data storage portion 14 for storing physical property data representing physical property values for members constituting the object to be analyzed.

The input portion 4 is implemented via an input device, for example, a pointing device such as a mouse and a track pad, and a keyboard as well. Upon a keyboard or the like device being operated by a user, a command corresponding to this operation is fed to the control section 2. Then, the control section 2 exercises control in response to this command. For example, through the operation of the input portion 4 by the user, the three dimensional configuration data, the physical property data, and so forth are respectively stored in the configuration data storage portion 13 and the physical property data storage portion 14.

The display portion 5 is implemented by a displaying device such as a cathode ray tube (CRT for short) display or a liquid crystal display (LCD for short). Under the control of the control section 2, the display portion 5 displays thereon the result of analysis.

Now, a description will be given below as to processing operations that are separately conducted by the individual portions at the time when the control section 2 performs structural analysis on an object to be analyzed. In order to simplify an understanding of the invention, the following description deals with specific processing operations that are conducted by the individual portions in a case where a hollow conical target object is subjected to structural analysis. For example, the structural analysis is performed by using the finite element method, the boundary element method, and the finite difference method. This embodiment will be described with respect to processing operations to be conducted by the individual portions in the case of performing structural analysis with use of the finite element method.

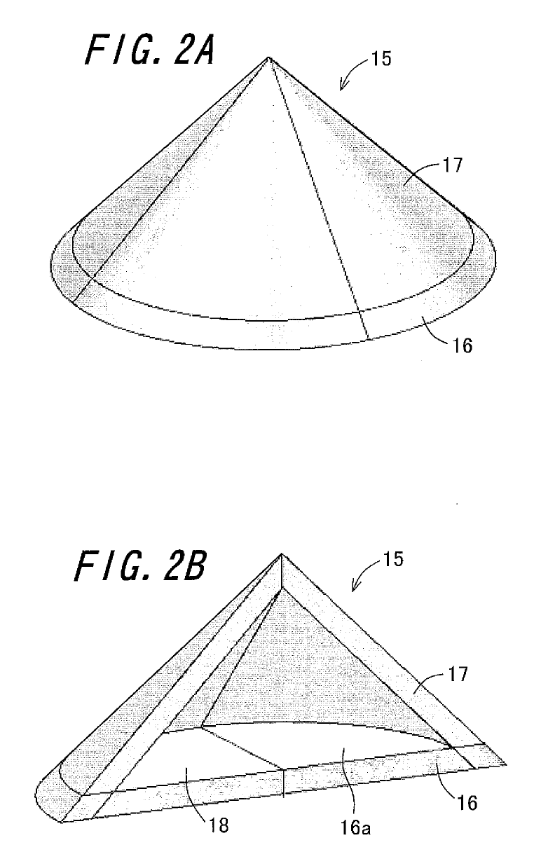

FIGS. 2A and 2B are perspective views showing a shape of an object to be analyzed represented by three dimensional configuration data in a visual manner. Hereinbelow, a model represented by the three dimensional configuration data will be referred to as a CAD model 15. FIG. 2A is a perspective view of a CAD model 15, whereas FIG. 2B is a perspective view showing a sectional profile of the CAD model 15. The three dimensional configuration data, which is generated by using a three dimensional CAD (computer aided design) system for instance, is a data group representing the shape of the object to be analyzed. The data group is stored in advance in the configuration data storage portion 13. In this embodiment, the to-be-analyzed object is composed of a disk-shaped bottom portion 16 and an umbrella-like portion 17 which is so formed as to extend, at one surface 16a of the bottom portion 16, from the outer edge to the vertex of the cone. In the to-be-analyzed object is formed a conical cavity 18 surrounded by the bottom portion 16 and the umbrella-like portion 17.

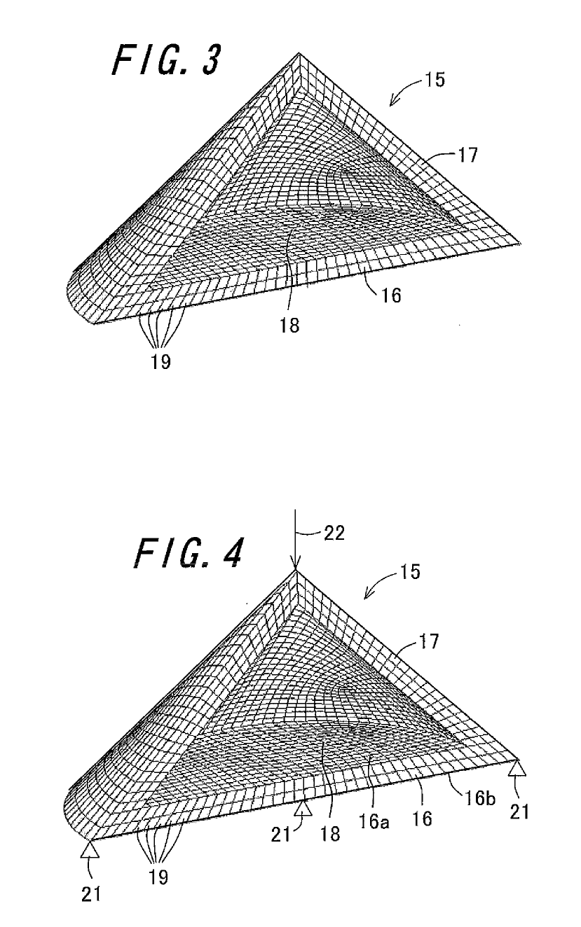

FIG. 3 is a perspective view showing a sectional profile of the CAD model 15 prepared by imaginarily dividing the to-be-analyzed object into a plurality of regions thereby to generate a mesh. The element dividing portion 6, which corresponds to a dividing portion for dividing the to-be-analyzed object composed of a plurality of members into a plurality of regions, is responsible for a dividing step. To be more specific, the element dividing portion 6 reads the three dimensional configuration data stored in the configuration data storage portion 13. Next, on the basis of the CAD model 15 represented by the read-in three dimensional configuration data, the element dividing portion 6 imaginarily divides the to-be-analyzed object into a plurality of regions thereby to generate a mesh. In this way, a plurality of finite elements 19 that correspond respectively to the individual regions are generated. For example, the generation of the mesh is achieved in accordance with the mesh function method, the block dividing method, the quadtree method, the advancing front method, the Delaunay triangulation method, or the like method.

FIG. 4 is a view schematically showing the CAD model 15 with a mesh generated and a fixing condition and pressure to be applied to the CAD model 15. The analytical condition setting portion 7 determines a single or a plurality of restraint conditions such as a fixed condition required to achieve structural analysis, a compulsory displacement condition, and a load condition. For example, these conditions can be inputted through the operation of the input portion 4 by the user. In this embodiment, the analyzing apparatus 1 performs structural analysis in a state where a force is applied to the vertex, with the other surface 16b of the bottom portion 16 opposite from the umbrella-like portion 17 secured in place. In FIG. 4, the positions to be fixed in the structural analysis are each indicated by a triangular symbol 21, and the position and direction for application of a force is indicated by an arrow 22.

Next, the analytical condition setting portion 7 relates the physical property value of the member to the finite element 19 thereby to produce an analytical model of the to-be-analyzed object. The analytical condition setting portion 7, which corresponds to a model generating portion, is responsible for a model generation step. In this embodiment, the to-be-analyzed object is composed of two members; that is, the bottom portion 16 and the umbrella-like portion 17. These members are formed of different materials.

Accordingly, the bottom portion 16 and the umbrella-like portion 17 differ in physical property value from each other. In this embodiment, the physical property value refers to information that indicates the physical property of a material required to achieve structural analysis. The physical property value includes, for example, Young's modulus, Poisson's ratio, and density.

The analytical condition setting portion 7 relates the physical property value of each member separately to the individual finite elements 19 constituting the bottom portion 16 and the umbrella-like portion 17. In this way, through the assignment of the physical property value of each member with respect to the CAD model 15 having the mesh generated, an analytical model is produced. The assignment of the physical property value may be effected by allowing the analytical condition setting portion 7 to read the physical property data representing the physical property values stored in advance in the physical property data storage portion 14. Alternatively, at the step of effecting the assignment of the physical property value, the physical property data inputted through the operation of the input portion 4 by the user may be used for the assignment. Note that the physical property data inputted through the operation of the input portion 4 by the user is stored in the physical property data storage portion 14.

The stress field computing portion 8 performs a simulation of applying a physical action on the analytical model and analyzes a resultant effect exerted on each of the regions. The stress field computing portion 8, which corresponds to an analyzing portion, is responsible for an analysis step. In the stress field computing portion 8, as has already been described, the structural analysis is performed by using the finite element method, the boundary element method, the finite difference method, or the like method. In this embodiment, the finite element method is adopted to perform the structural analysis. To be specific, with respect to each node point corresponding to the vertex of each of the finite elements 19, a first-degree equation is derived in accordance with Hooke's law.

The first-degree equation is expressed by the following formula (1):

F=k×x (1)

In the formula (1), the symbol “F” represents a force exerted on the node point, the symbol “k” represents a constant of spring, and the symbol “x” represents a displacement. To be more specific, in the stress field computing portion 8, an equation of motion is derived for each of the node points in a state where each of the sides of the finite element 19 is replaced with an imaginary spring. Since the node point of interest is connected to a plurality of node points by the imaginary spring, it follows that a force exerted on the node point of interest is defined as a superposition of forces received from a plurality of imaginary springs. Herein, a constant of spring is determined on the basis of the physical property value described above. Moreover, in addition to the force exerted by the imaginary spring, the above-described force is added to the vertex of the cone. Further, in each of the node points for which the fixing condition is determined, the displacement is set at 0.

The first-degree equation derived for each of the node points includes the node point of interest and the displacement of a plurality of node points which are connected to the node point of interest by way of the imaginary spring. Accordingly, a plurality of first-degree equations thereby derived are each defined as a simultaneous linear equation. Upon this simultaneous linear equation being solved by the stress field computing portion 8, as the effects exerted on each of the finite elements 19, displacement vector, stress tensor, strain tensor, etc. for each of the node points are obtained.

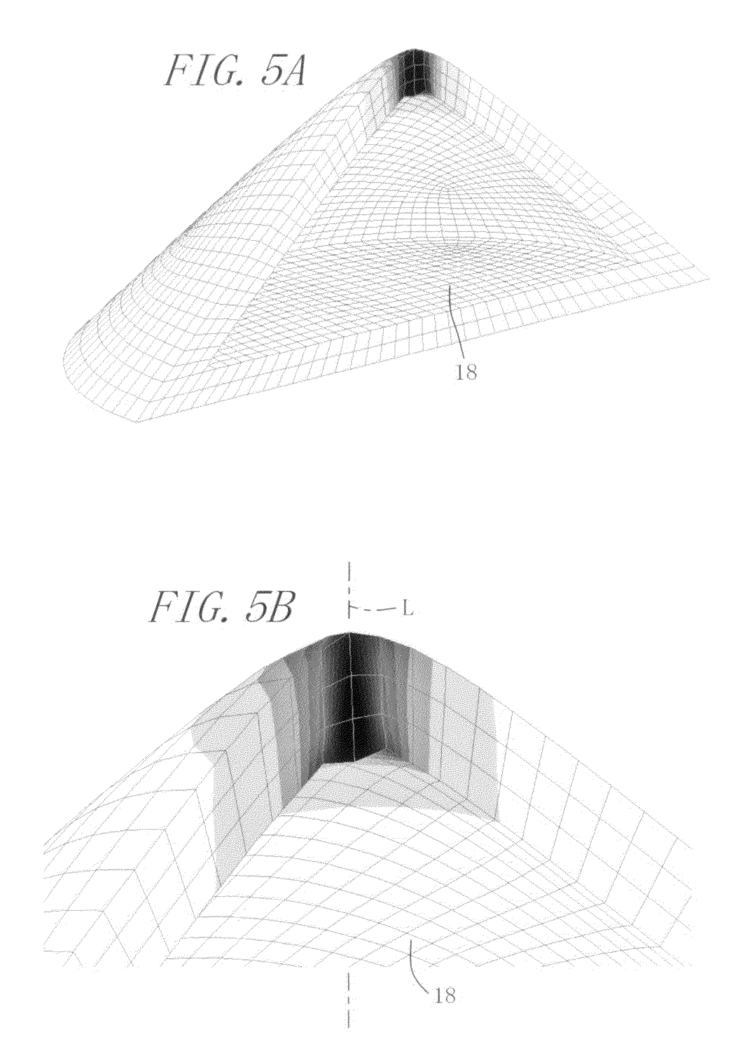

FIGS. 5A and 5B are views showing an analytical model under pressure and a maximum principal stress. In FIGS. 5A and 5B, the distribution of the maximum stress's magnitude is represented in such a manner that, the greater is the maximum principal stress, the darker is the analytical model. Although, in FIGS. 5A and 5B, variation of the magnitude of the maximum principal stress is represented by the change of the lightness of color, any other representation can arbitrarily be adopted so long as the magnitude of the maximum principal stress is indicated properly. For example, in accordance with the magnitude of the maximum principal stress, a plurality of hatch patterns of different types may be provided or a different hue may be taken on. FIG. 5A is a perspective view showing the sectional profile of the analytical model, whereas FIG. 5B is an enlarged perspective view showing the sectional profile of the vertex portion of the analytical model. The maximum principal stress stands at the highest level in an area contiguous to the cavity 18 on an axis L of the vertex portion, and decreases with distance from this area. The area bearing a significant maximum principal stress is located inside the analytical model and is thus not viewable in the perspective view of the analytical model.

The safety factor calculating portion 9, which corresponds to a safety factor calculating portion in which a comparison is made between the effect exerted on each of the finite elements 19 and a reference value which is set for each of the members in advance thereby to calculate a safety factor for each of the finite elements 19 on an individual basis, is responsible for a safety factor calculation step. In this embodiment, the safety factor calculating portion 9 calculates, as a safety factor, a strength safety factor which indicates the durability of the to-be-analyzed object in a state of receiving application of a force expected to be applied to the to-be-analyzed object.

The safety factor calculating portion 9 reads the reference value predetermined separately for the individual members from the physical property data storage portion 14. The reference value is included in the physical property data on each member stored in the physical property data storage portion 14. While, in this embodiment, the reference value stored in advance in the physical property data storage portion 14 is loaded, it is also possible to read, at the step of allowing the safety factor calculating portion 9 to read the reference value, a reference value inputted through the operation of the input portion 4 by the user.

The reference value is set for each of the members on an individual basis in advance. In this embodiment, since the bottom portion 16 and the umbrella-like portion 17 are formed of different structural components, it follows that the safety factor calculating portion 9 reads the reference values of the bottom portion 16 and the umbrella-like portion 17, respectively. The reference value refers to a value of stress or strain, for instance, and is determined in accordance with the kind of the member. For example, in a case where the member is formed of a homogeneous elasto-plastic material such as a metal material or a resin material, a yield stress is generally selected as the reference value. On the other hand, in a case where the member is formed of a brittle material such as glass or concrete, a rupture stress or rupture strain is generally selected as the reference value. In this embodiment, a predetermined reference value is set to a yield stress or yield strain.

In the safety factor calculating portion 9, before a comparison is made between the effect exerted on each of the finite elements 19 and the reference value predetermined separately for the individual members, on the basis of a conversion equation which is set for each of the members in advance, the effect expressed in tensor form is converted into a scalar form.

The conversion equation varies depending upon the characteristics of each member and is thus set for each of the members on an individual basis. For example, with respect to the member formed of an elasto-plastic material such as a metal material or a resin material, a conversion equation for allowing a conversion into Von Mises stress is adopted. The conversion equation is expressed by the following formula (2):

von Mises stress=(σ₁−σ₂)²+(σ₂−σ₃)²+(σ₃−σ₁)² (2)

In the formula (2), the symbol “σ₁” represents the maximum principal stress, the symbol “σ₂” represents the middle principal stress, and the symbol “σ₃” represents the minimum principal stress.

On the other hand, for example, with respect to the member formed of a brittle material such as glass or concrete, a conversion equation for allowing a conversion into Tresca stress is adopted. The conversion equation is expressed by the following formula (3):

Tresca stress=σ₁−σ₂ (3)

In the formula (3), the symbol “σ₁” represents the maximum principal stress and the symbol “σ₃” represents the minimum principal stress.

Moreover, for example, with respect to the member formed of a brittle material such as glass or concrete, it is also possible to effect a conversion for extracting, from stress tensors expressed in tensor form, the maximum principal stress σ₁ expressed in scalar form, as well as a conversion for extracting, from strain tensors expressed in tensor form, a maximum principal strain Ε₁ expressed in scalar form.

The above-described conversion equations for their respective members are each stored in the physical property data storage portion 14 as physical property data. In the safety factor calculating portion 9, after the physical property data is read from the physical property data storage portion 14, on the basis of the conversion equation, the effect expressed in tensor form is converted into a scalar form. Alternatively, in the safety factor calculating portion 9, instead of reading the physical property data stored in advance in the physical property data storage portion 14, a conversion equation inputted through the operation of the input portion 4 by the user may be loaded at the step of allowing the safety factor calculating portion 9 to read the physical property data.

In the safety factor calculating portion 9, a comparison is made between the stress or strain, now converted into a scalar form, and the reference value predetermined separately for the individual members thereby to calculate the strength safety factor for each of the finite elements 19 on an individual basis. To be more specific, with the provision of the stress or strain converted into a scalar form in accordance with the conversion equation such as the formula (2) and the formula (3) as a scalar equivalent value, then the safety factor calculating portion 9 calculates the strength safety factor in accordance with the following formula (4):

$$Strength safety factor = \frac{Reference value}{Scalar equivalent value}$$

In this way, by dividing the reference value by the scalar equivalent value, it is possible to obtain a normalized strength safety factor by calculation. In this embodiment, the yield stress or yield strain for each of the members is used as the reference value. It will thus be seen that the finite element 19 with a strength safety factor of less than 100%, regardless of the kind of the member thereof, goes beyond its yield point.

The display control portion 10 effects control of the display portion 5 so as to display the strength safety factor of each of the finite elements 19 along with the analytical model in a unified manner. That is, the display control portion 10 generates image data for display purposes that represents the analytical model with additional strength safety factors, and feeds this image data to the display portion 5.

At first, the display control portion 10 effects control of the display portion 5 so that the analytical model is displayed, and in addition the strength safety factor is superposed on the analytical model according to its level, whereupon the analytical model with the strength safety factor is displayed in contour or level-line representation.

Next, the display control portion 10 of this embodiment effects control of the display portion 5 so as to display each of the finite elements 19 in transmissivity representation in accordance with the corresponding strength safety factor. To be specific, the transmissivity is so determined as to become increasingly higher as the safety factor is increased. To be more specific, the region having a high strength safety factor is displayed in transparent or semi-transparent representation.

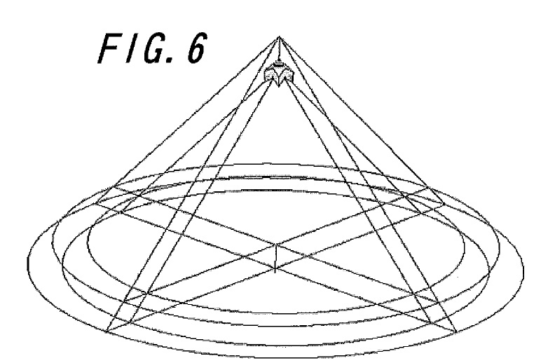

FIG. 6 is a view of a result of the structural analysis, illustrating the strength safety factor of each of the finite elements 19 indicated with the analytical model in a unified manner. In this embodiment, the level of the strength safety factor is classified under two groups. In determining a threshold value required to classify the level of the strength safety factor under two groups, there is a need to secure a margin for the strength safety factor. Thus, for example, the threshold value is defined by a strength safety factor such as to bring about the necessity of making changes to the design. For example, the threshold value is set at 200%. This threshold value is determined in accordance with product specifications, for instance. In this embodiment, in a case where the strength safety factor of the finite element 19 is less than 200%, the transmissivity will be given as 0%; that is, the finite element is represented opaquely. On the other hand, in a case where the strength safety factor of the finite element 19 is greater than or equal to 200%, the transmissivity will be given as 100%; that is, the finite element is represented transparently. The analytical model is displayed in that way. TI all of the finite elements 19 having a strength safety factor of 200% or above are represented transparently, it will be difficult to figure out the positions of the regions represented opaquely in the to-be-analyzed object as a whole. Therefore, a part of the frame is displayed.

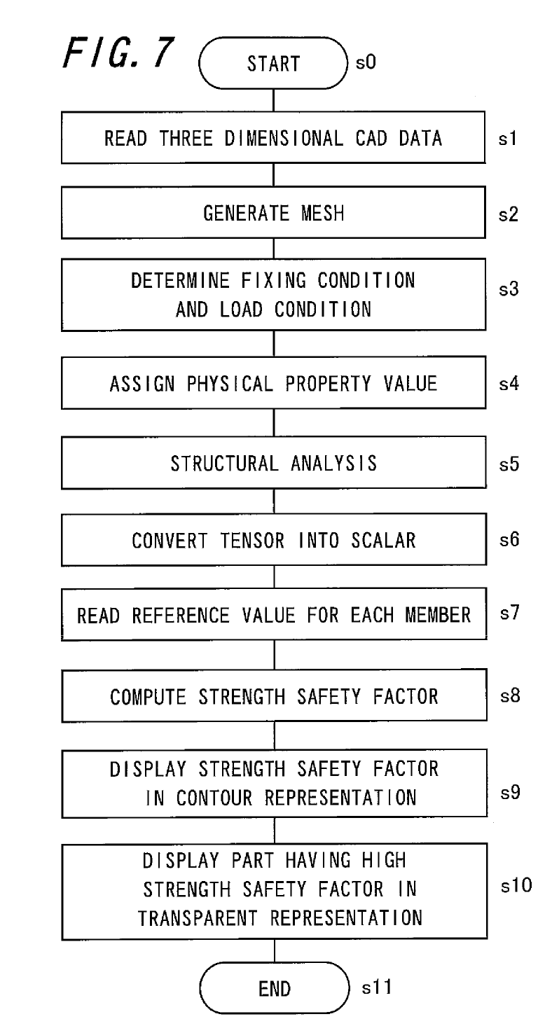

FIG. 7 is a flow chart showing procedural steps to be followed by the control section 2. Upon start-up of the structural analysis operation, the procedure proceeds from Step s0 to Step s1. At Step s1, the element dividing portion 6 reads the three dimensional CAD data representing the to-be-analyzed object from the configuration data storage portion 13. Next, the procedure proceeds to Step s2 where, on the basis of the three dimensional CAD data, the element dividing portion 6 divides the to-be-analyzed object composed of a plurality of members into a plurality of finite elements 19 thereby to generate a mesh.

Next, the procedure proceeds to Step s3 where the analytical condition setting portion 7 determines a fixing condition and a load condition with respect to the CAD model 15 with the mesh thus generated. Subsequently, the procedure proceeds to Step s4 where the analytical condition setting portion 7 reads the physical property data on each of the members stored in the physical property data storage portion 14, and relates the physical property value of the member to the finite element 19 thereby to produce an analytical model of the to-be-analyzed object.

Next, the procedure proceeds to Step s4 where the stress field computing portion 8 performs, on the basis of the analytical model thereby generated, a simulation of applying a physical action on the analytical model and analyzes a resultant effect exerted on each of the finite elements 19. With this structural analysis performed by the stress field computing portion 8, it is possible to obtain displacement vector, stress tensor, strain tensor, and the like at each node point.

Next, the procedure proceeds to Step s6 where the safety factor calculating portion 9 performs a conversion from the effect expressed in tensor form, such as stress tensor and strain tensor at each node point calculated through the structural analysis, into a scalar form on the basis of the conversion equation predetermined separately for the individual members. For example, the physical property data on each of the members stored in the physical property data storage portion 14 is used for the conversion equation. Subsequently, the procedure proceeds to Step s7 where the safety factor calculating portion 9 reads, out of the physical property data stored in the physical property data storage portion 14, the reference value set for each of the members. For example, the reference value is set to a yield stress or yield strain, depending upon the kind of the member. Next, the procedure proceeds to Step s8 where the safety factor calculating portion 9 calculates a strength safety factor in accordance with the above-described formula (4).

Next, the procedure proceeds to Step s9 where the display control portion 10 effects control of the display portion 5 so as to display the analytical model with the strength safety factor superposed thereon, which is indicated in contour representation according to the level of the strength safety factor. Subsequently, the procedure proceeds to Step s10 where the display control portion 10 effects control of the display portion 5 so as to display the result of the structural analysis; that is, a region having a strength safety factor higher than the threshold value is represented transparently. Upon the indication of the result of the structural analysis on the display portion 5, the procedure proceeds to Step s11, whereupon the operation comes to an end.

According to the analyzing apparatus 1 of this embodiment described thus far, the analytical condition setting portion 7 relates the physical property value of the member to the finite element 19 thereby to produce an analytical model of the to-be-analyzed object. Accordingly, even if the to-be-analyzed object is composed of a plurality of members, the analytical model thus generated succeeds in offering a simulated to-be-analyzed object composed of a plurality of members with high accuracy.

The stress field computing portion 8 performs a simulation of applying a physical action on the above-described analytical model and analyzes a resultant effect exerted on each of the regions. In the safety factor calculating portion 9, a comparison is made between the effect exerted on each of the finite elements 19 and the reference value predetermined separately for the individual members. In this way, a safety factor is obtained by calculation for each of the finite elements 19 on an individual basis. With use of such a reference value predetermined separately for the individual members, even if the to-be-analyzed object is composed of a plurality of members, it is possible to obtain a safety factor by calculation with high accuracy.

The display portion 5 displays thereon the safety factor of each of the finite elements 19 along with the analytical model in a unified manner. If the maximum principal stress such as shown in FIGS. 5A and 5B is displayed without the indication of the safety factor, the evaluation of product design will be impossible without knowledge about the physical property value of each of the members, product specifications, and so forth. In this regard, according to this embodiment, a simulation is performed with use of an analytical model of an object to be analyzed composed of a plurality of members, and a safety factor based on the result of the analysis is indicated. Accordingly, by making a visual identification of the indication, it is possible to achieve the evaluation of the to-be-analyzed object composed of a plurality of members with ease without the necessity of having the knowledge of the physical property value of each of the members and so forth.

Moreover, since a strength safety factor is normalized in accordance with the formula (4), even if the to-be-analyzed object is composed of a plurality of members, it is possible to make evaluations of product design without reference to the kinds of members.

Moreover, according to the analyzing apparatus 1 of this embodiment, the transmissivity of the finite element 19 is so determined as to become increasingly higher as the safety factor is increased. That is, the region with a higher safety factor is represented transparently, on one hand, and the region with a lower safety factor is represented opaquely, on the other hand. By doing so, even in a case where the region with a high safety factor exists on the surface area of the to-be-analyzed object and the region with a low safety factor exists in the to-be-analyzed object interiorly thereof, through a visual identification of the display, it is possible to recognize the presence of the region with a low safety factor inside the to-be-analyzed object and thereby facilitate the evaluation of the to-be-analyzed object. For example, as shown in FIG. 6, even in the presence of the region with a low safety factor inside the to-be-analyzed object, since the region with a high safety factor, which is so located as to cover the region with a low safety factor, is represented transparently, it is possible to visually recognize the region with a low safety factor with ease and thereby facilitate the evaluation of the to-be-analyzed object.

Further, according to the analyzing apparatus 1 of this embodiment, the predetermined reference value is set to a yield stress or yield strain. Accordingly, the safety factor is obtained by calculation on the basis of the yield stress or yield strain. With the adoption of such a reference value, there is indicated the safety factor of the to-be-analyzed object with respect to a yield point. This makes it possible to evaluate the to-be-analyzed object without the necessity of examining the yield stress or yield strain of each of the members one by one. In this embodiment, it will be understood that the finite element 19 with a strength safety factor of less than 100% goes beyond its yield point.

Still further, according to the analyzing apparatus 1 of this embodiment, the safety factor calculating portion 9 converts the effect expressed in tensor form into a scalar form in accordance with the conversion equation predetermined separately for the individual members. In the safety factor calculating portion 9, a comparison is made between the effect, now expressed in scalar form after conversion, and the predetermined reference value. In this case, in contrast to the case of making a comparison between the effect which still remains in tensor form and the predetermined reference value, the amount of operation can be reduced. Moreover, the conversion equation is set separately for the individual members. Accordingly, even if the to-be-analyzed object is composed of a plurality of members of different kinds, in contrast to the case of converting the effects exerted on all of the members into a scalar form with use of a single conversion equation, the evaluation of the to-be-analyzed object can be achieved with higher accuracy.

Next, a description will be given below as to a case where the analyzing apparatus 1 of this embodiment is applied to another object to be analyzed that is different from the above-described to-be-analyzed object having the shape of a cone. The another to-be-analyzed object subjected to structural analysis is an assembly composed of a plurality of components that are made of different materials. The constituent components of this embodiment correspond to the members as described thus far, respectively.

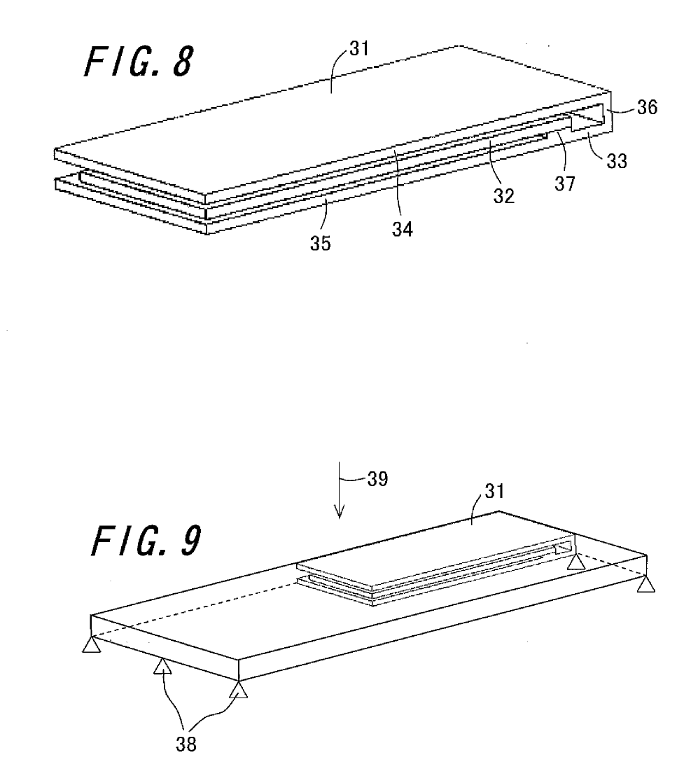

FIG. 8 is a perspective view showing a shape of the to-be-analyzed object represented by three dimensional configuration data in a visual manner. The to-be-analyzed object takes on the shape of a longitudinal plate. In order to simplify an understanding of the invention, the to-be-analyzed object is divided into halves in a transverse direction, and the halves are each further divided into halves in a lengthwise direction. Out of the four segments obtained by dividing the to-be-analyzed object in quarter, only a single piece of CAD model 31 is depicted in FIG. 8. Also in the following description, out of the four segments obtained by dividing the CAD model 31 in quarter, a single piece (hereinafter referred to as a ¼ model) will be presented in order to simplify an understanding of the invention.

The to-be-analyzed object is composed of a plate-like component 32, which is of a relatively fragile longitudinal plate, and an enclosure component 33 for providing protection for the plate-like component 32. The enclosure component 33 is composed of a one plate body 34, an other plate body 35, a connecting body 36, and a supporting body 37. The one plate body 34 is arranged on one side of the plate-like component 32 in the direction of thickness thereof, with a narrow spacing secured therebetween, for the plate-like component 32 to be covered at its one thicknesswise side. The other plate body 35 is arranged on the other side of the plate-like component 32 in the direction of thickness thereof, with a narrow spacing secured therebetween, for the plate-like component 32 to be covered at its other thicknesswise side. The connecting body 36 is so formed as to extend in the thicknesswise direction with respect to one lengthwise end of the one plate body 34 and one lengthwise end of the other plate body 35, for providing a connection between the one plate body 34 and the other plate body 35. The supporting body 37 is so formed as to extend from the other plate body 35 in one of the thicknesswise directions to its junction with one lengthwise end of the plate-like component 32, for supporting the plate-like component 32.

FIG. 9 is a view showing a CAD model 31 and a fixing condition and pressure to be applied to the CAD model 31 in a conceptual manner. In order to simplify an understanding of the invention, in FIG. 9, the external configuration of the to-be-analyzed object is also depicted. In this embodiment, the analyzing apparatus 1 performs structural analysis in a state where a pressure is applied to the to-be-analyzed object from one thicknesswise side thereof, with the other thicknesswise side surface of the to-be-analyzed object fixed in place. The positions to be fixed in the structural analysis are each indicated by a triangular symbol 38, and the direction that applies a pressure is indicated by an arrow 39.

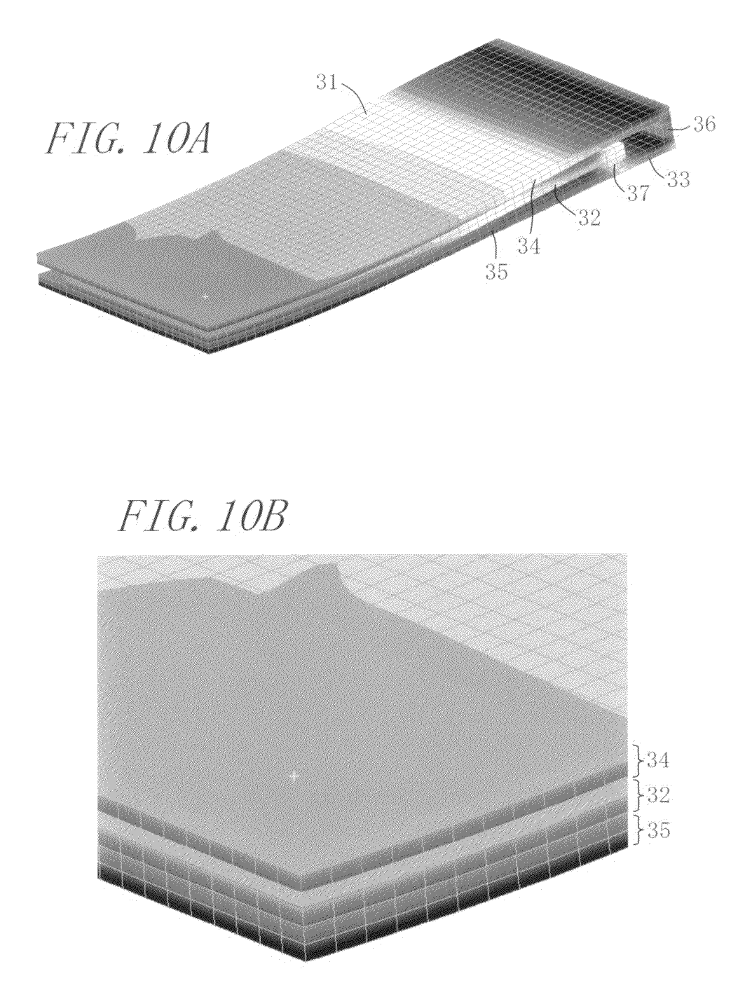

In conformity with the restraint conditions shown in FIG. 9, the analyzing apparatus 1 goes through the procedure shown in FIG. 7 to achieve structural analysis on the to-be-analyzed object shown in FIG. 8. Hereinafter, with reference to FIGS. 10A and 10B through 12A and 12B, the result of analysis will be explained.

FIGS. 10A and 10B are views showing an analytical model under pressure and a maximum principal stress. In FIGS. 10A and 10B, the analytical model is illustrated as darkening in color increasingly as the maximum principal stress is increased. In so doing the distribution of magnitude of the maximum stress is represented. FIG. 10A is a perspective view showing the ¼ model, and FIG. 10B is an enlarged view showing that part of the construction shown in FIG. 10A which exhibits a significant maximum principal stress.

As shown in FIG. 10B, upon application of a pressure to the to-be-analyzed object from one thicknesswise side thereof, the one plate body 34 and the plate-like component 32 undergo a deflection in the direction in which the pressure is applied. As a consequence, a gap between the enclosure component 33 and the plate-like component 32 is gone and thus these components are brought into abutment with each other. Moreover, in terms of the maximum principal stress, the plate-like component 32 is greater than the one plate body 34 which receives the application of the pressure, and further the other plate body 35 is greater than the plate-like component 32. It will thus be seen that the stress is concentrated on the other plate body 35. By performing structural analysis in that way, it is possible to recognize which part of the construction is to be subjected to the concentration of stress. However, since physical properties such as a strength vary from member to member, it will be impossible to ascertain the attainment of safety in the strength aspect with the stress data alone.

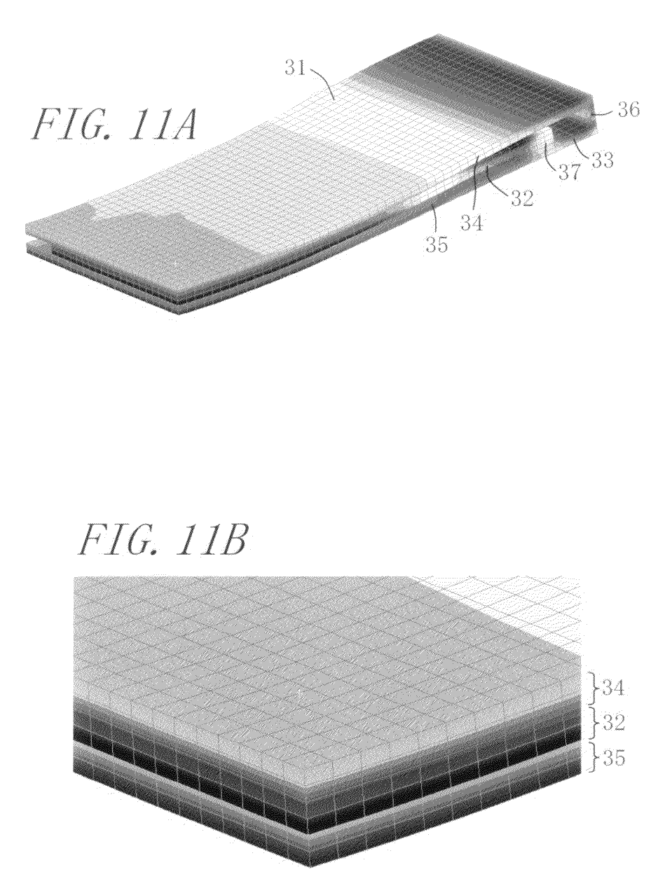

FIGS. 11A and 11B are views showing an analytical model under pressure and the indication of strength safety factor. In FIGS. 11A and 11B, the analytical model is illustrated as darkening in color increasingly as the strength safety factor is decreased. In so doing the distribution of largeness of the strength safety factor is represented. FIG. 11A is a perspective view showing the ¼ model, and FIG. 11B is an enlarged view showing that part of the construction shown in FIG. 11A which exhibits a low strength safety factor. As shown in FIG. 11B, as compared with the enclosure component 33, a the other plate body 35—sided part of the plate-like component 32 exhibits the lowest strength safety factor. In this way, with the indication of the normalized strength safety factor instead of a stress, it is possible to recognize the safety factor of the to-be-analyzed object composed of different members with ease without the necessity of having knowledge about the physical property value of each of the members, product specifications, and so forth.

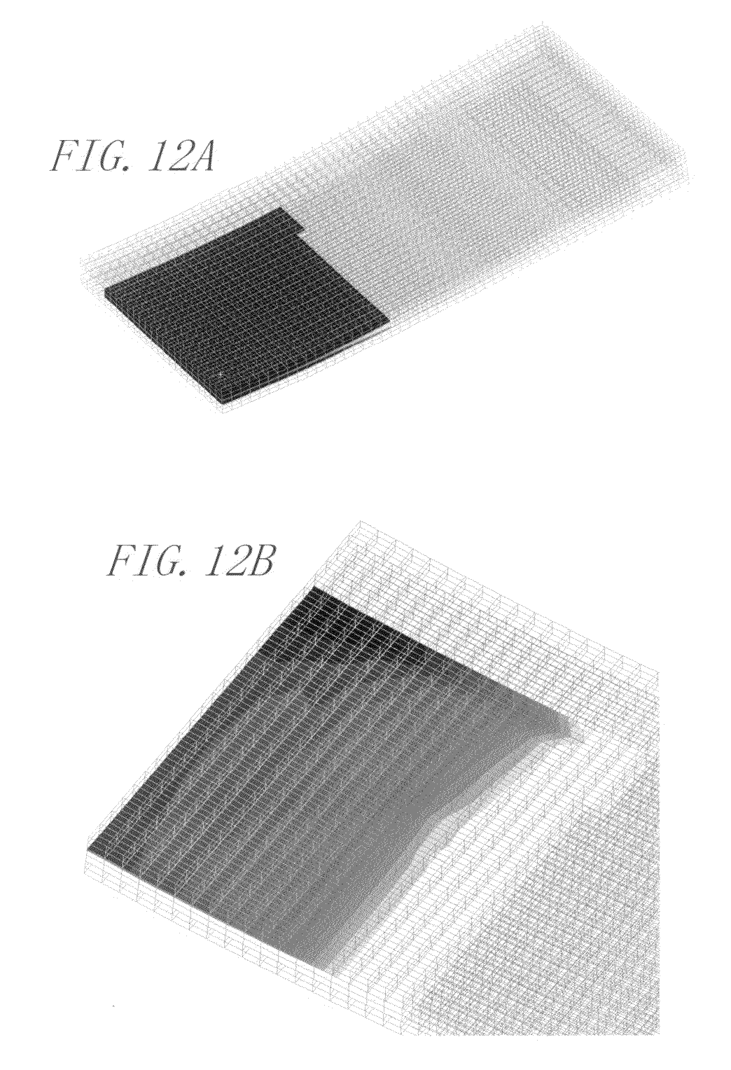

FIGS. 12A and 12B are views of a result of structural analysis, illustrating the strength safety factor of each of the finite elements represented with the analytical model in a unified manner, with the transmissivity varying according to the strength safety factor. FIG. 12A is a perspective view showing the ¼ model, and FIG. 12B is an enlarged view showing the to-be-analyzed object when viewed as from the other thicknesswise side thereof, with respect to the region with a low strength safety factor.

As shown in FIGS. 12A and 12B, the region with a high strength safety factor is represented transparently. Accordingly, even in the case of checking the plate-like component 32 covered with the enclosure component 33, it is possible to make a visual identification of the strength safety factor of the plate-like component 32 which is low in strength safety factor.

In this embodiment, the finite element 19 whose strength safety factor is higher than the threshold value is represented with its transmissivity given as 100%. However, the requirement is not limited to 100% but may be of 50%, for instance. It is also possible to represent the finite element in such a manner that, the higher is the strength safety factor, the higher is the transmissivity, irrespective of the threshold value. In another alternative, under the condition that the transmissivity of the finite element 19 whose strength safety factor is higher than the threshold value is set at a fixed value, the finite element 19 whose strength safety factor is lower than the threshold value may be represented in such a manner that, the higher is the strength safety factor, the higher is the transmissivity.

Moreover, each of the finite elements 19 may be represented by a transmissivity which depends upon a safety factor. For example, it is possible to represent the finite elements 19 in such a manner that, the lower is the strength safety factor, the lower is the transmissivity. For example, if the transmissivity is so represented as to become increasingly higher as the strength safety factor is increased, in a case where there is a concentration of the regions having a low strength safety factor on the surface area of the to-be-analyzed object, it will be impossible to ascertain the result of analysis about the inside of the to-be-analyzed object. In light of this, by representing the finite element 19 in such a manner that the transmissivity becomes increasingly lower as the strength safety factor is decreased, it is possible to ascertain the result of analysis about the inside of the to-be-analyzed object. In this way, by representing each of the finite elements 19 by a safety factor-related transmissivity, it is possible to ascertain the result of analysis about the inside of the to-be-analyzed object without fail.

Moreover, in this embodiment, the analyzing apparatus 1 is designed to perform structural analysis and display a strength safety factor as the result of analysis. However, the invention is not limited to structural analysis and can therefore be applied also to thermal analysis. In the case of performing thermal analysis, a safety factor may be obtained by calculation with application of an allowable temperature as a reference value, for instance.

Further, while the above description deals with the case where the safety factor is obtained by calculation in accordance with the formula (4), the invention is not limited to this formula. For example, it is possible to use a value obtained by subtracting the reference value from the scalar equivalent value, or use a value obtained by dividing the value obtained by subtracting the reference value from the scalar equivalent value by the reference value.

Still further, while the above description deals with the case where, at the step of calculating the safety factor, after such an effect as a strain or stress is converted from a tensor form into a scalar form, the effect in scalar form is compared with the reference value expressed in scalar form, it is also possible to use a reference value expressed in tensor form. In this case, a comparison is made between two tensor values. For example, after a calculation is made to obtain the safety factor with respect to a plurality of tensor values on an individual basis as is the case with the formula (4), the mean value of the calculation results is employed as the safety factor.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An analytical method comprising:
a dividing step of dividing a to-be-analyzed object composed of a plurality of members into a plurality of regions;
a model generation step of generating an analytical model of the to-be-analyzed object by relating a physical property value of each of the members separately to the individual regions;
an analysis step of performing a simulation of applying a physical action to the analytical model and analyzing a resultant effect exerted on each of the regions;
a safety factor calculation step of making a comparison between the effect exerted on each of the regions and a reference value which is set for each of the members in advance thereby to calculate a safety factor for each of the regions on an individual basis; and
a display step of indicating the safety factor for each of the regions along with the analytical model in a unified manner.

2. The analytical method of claim 1, wherein, in the display step, each of the regions is displayed in transmissivity representation in accordance with a safety factor.

3. The analytical method of claim 2, wherein, in the display step, the transmissivity is so determined as to become increasingly higher as the safety factor is increased.

4. The analytical method of claim 1, wherein the predetermined reference value is a yield stress or yield strain.

5. The analytical method of claim 1, wherein, in the analysis step, the effect is calculated in terms of tensor, in the safety factor calculation step, the effect expressed in tensor form is converted into a scalar form on the basis of the conversion equation predetermined separately for the individual members, and the effect, now expressed in scalar form after conversion, is compared with the reference value set for each of the members in advance.

6. A computer-readable recording medium on which a program is recorded for allowing a computer to execute:
a dividing step of dividing a to-be-analyzed object composed of a plurality of members into a plurality of regions;
a model generation step of generating an analytical model of the to-be-analyzed object by relating a physical property value of each of the members separately to the individual regions;
an analysis step of performing a simulation of applying a physical action to the analytical model and analyze a resultant effect exerted on each of the regions;
a safety factor calculation step of making a comparison between the effect exerted on each of the regions and a reference value which is set for each of the members in advance thereby to calculate a safety factor for each of the regions on an individual basis; and
a display step of indicating the safety factor for each of the regions along with the analytical model in a unified manner.

7. An analyzing apparatus comprising:
a dividing portion which divides a to-be-analyzed object composed of a plurality of members into a plurality of regions;
a model generating portion which generates an analytical model of the to-be-analyzed object by relating a physical property value of each of the members separately to the individual regions;
an analyzing portion which carries out a simulation of applying a physical action to the analytical model and analyzes a resultant effect exerted on each of the regions;
a safety factor calculating portion which makes a comparison between the effect exerted on each of the regions and a reference value which is set for each of the members in advance thereby to calculate a safety factor for each of the regions on an individual basis; and
a display portion which indicates the safety factor for each of the regions along with the analytical model in a unified manner.
